(19) United States
(12) Patent Application Publication
(10) Pub. No.: US 2004/0130575 A1
(43) Pub. Date: Jul. 8, 2004

(54) Method of displaying a software keyboard

(75) Inventors: Lu-Yun Tai, Taoyuan (TW); Hung-Ming Chen, Taipei (TW)

Correspondence Address: BACON & THOMAS, PLLC, 625 SLATERS LANE, FOURTH FLOOR, ALEXANDRIA, VA, 22314

(73) Assignee: Tatung Co., Ltd., Taipei (TW)

(21) Appl. No.: 10/395,164

(22) Filed: Mar. 25, 2003

(30) Foreign Application Priority Data
Jan. 3, 2003 (TW) 92100129

(51) Int. Cl. G09G 5/00

(52) U.S. Cl. 345/773

(57) ABSTRACT

An information device is used to execute at least one application program and has a display for displaying a software keyboard and a corresponding widow opened after one application program is executed. The window has at least one input area and one non-input area, and when a caret symbol appears in the input area, an input process can be performed after the caret symbol. If one input area on the active window has a caret symbol, then the software keyboard is presented on the display; otherwise, the software keyboard is hidden. The software keyboard appears near the caret symbol, or at a predetermined position.

### BACKGROUND OF THE INVENTION

1. Field of the Invention

The present invention relates to a method of displaying a software keyboard, and more particularly to a method of automatically displaying a software keyboard in an input area, which is suitable for an information device with a display.

2. Description of the Related Art

The prior art software keyboard (also called a screen keyboard) displays a graphical user interface on a display (such as a computer screen, a mobile phone, a PDA screen, or a touch screen) for displaying alphanumeric keys, symbol keys, function keys, etc., thereby enabling a user to perform an input process by selecting these keys.

However, in a prior art information device, when the user executes an application and wants to perform the input process in an input area of a window opened by the application (a flashing caret symbol will be generated in the input area to show a present input position), the user has to click another application for the software keyboard to display the software keyboard on the display. Furthermore, when the user changes to another window to perform the input process again, he or she still needs to click the application for the software keyboard to display the software keyboard on the display, which is very inconvenient. This process is even more tedious if the information device utilizes a touch screen as the primary input tool. Prior art applications exist that can call up the input tool by reading a window message, but still no automatic displaying function of the software keyboard for an entire window system is provided.

The prior art software keyboard is usually displayed at a fixed position (for example, at the lower right corner of the display according to a predetermined coordinate value), but the input area may be inadvertently covered by the software keyboard, thus requiring the user to drag the software keyboard to another corner.

Therefore, it is desirable to provide an improved software keyboard to mitigate and/or obviate the aforementioned problems.

### SUMMARY OF THE INVENTION

The main objective of the present invention is to provide a method of displaying a software keyboard which can automatically detect a caret symbol displayed on an input area of an active window to display the software keyboard on the display.

Another objective of the present invention is to provide a method of displaying a software keyboard which can display the software keyboard near the caret symbol according to a coordinate value of the caret symbol, and avoid covering the input area to improve operational convenience.

One more objective of the present invention is to provide a method of displaying a software keyboard which is capable of moving according to a movement of the caret symbol.

In order to achieve the above-mentioned objectives, the present invention discloses a method of displaying a software keyboard in an information device. The information device is used to execute at least one application program, having a display for displaying the software keyboard and a corresponding widow opened after one application program is executed. The window has at least one input area and one non-input area, and when a caret symbol appears in the input area, an input process is performed after the caret symbol. The method comprises: detecting if one input area on the active window has a caret symbol, and if so displaying the software keyboard on the display.

The present invention can be implemented by way of a software program, and the present invention can be written in an appropriate computer language to be loaded onto a computer readable medium. The medium can be an IC chip, a hard disk, an optical disk or any other software recording medium, but random access memory is considered a better choice as it is easy to update.

Other objects, advantages, and novel features of the invention will become more apparent from the following detailed description when taken in conjunction with the accompanying drawings.

### BRIEF DESCRIPTION OF THE DRAWINGS

FIG. 1 is a flowchart of a first embodiment according to the present invention.

FIG. 2 is a schematic drawing of the flowchart of the first embodiment according to the present invention.

FIG. 3 is another schematic drawing of the flowchart of the first embodiment according to the present invention.

FIG. 4 is a schematic drawing of the software keyboard after switching to another window according to the present invention.

FIG. 5 is a flowchart of a second embodiment according to the present invention.

FIG. 6 is a schematic drawing of the software keyboard of the second embodiment according to the present invention.

### DETAILED DESCRIPTION OF THE PREFERRED EMBODIMENT

An embodiment of the present invention is applied in an information apparatus. The information apparatus has a display, such as a computer monitor, a mobile phone screen, a PDA (personal digital assistant) or a touch screen, for displaying a window (like an Office Word window, or a webpage window) and a software keyboard opened by an application. If the display is a touch screen, input from alphanumeric keys, symbol keys or function keys on the software keyboard is obtained by a user using his or her fingers, or a touch pen, to click on the corresponding keys. If the display is a standard screen, the primary purpose of the software keyboard is to prompt the user about the desired keyboard arrangement mode. However, the user can also use a mouse to click those keys on the software keyboard to provide corresponding key entry input.

The window opened by the above-mentioned application has at least one input area and one non-input area. In the input area, the characters input by the user are displayed after a caret symbol that is displayed in the window. The caret symbol changes position with each input character. Taking the Office Word application as an example, in the opened window, a block that allows the user to edit document content serves as the input area, and a block that does not allow the user to edit document content serves as the non-input area, and may include a scroll bar superposed on top of the window. The caret symbol usually first appears at a beginning of the document, which is at the fist row and the first line, and is displayed as a flashing “I” or “|”symbol to indicate the character position to the user of the next input character. Naturally, position of the caret symbol can be controlled by a cursor, and when the cursor is clicked on another input area, or another paragraph of text in document, the caret symbol will move as indicated by the cursor. Taking an internet browser as an example, when the user links to a website and wishes to register as a member, every column (including, for example, a name column, an account number column, a password column, etc.) in the webpage is an input area; if the caret symbol appears in the name column, then the characters provided by the user are displayed in the name column. However, each information apparatus only has one caret symbol.

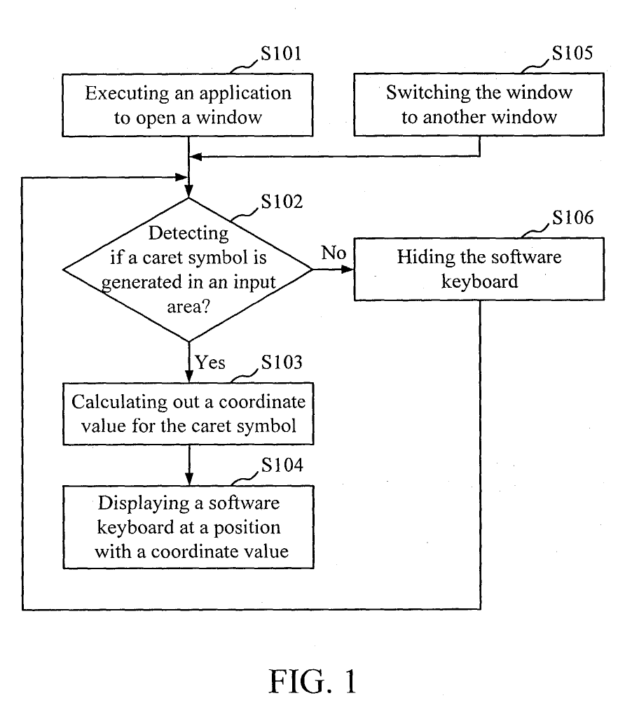

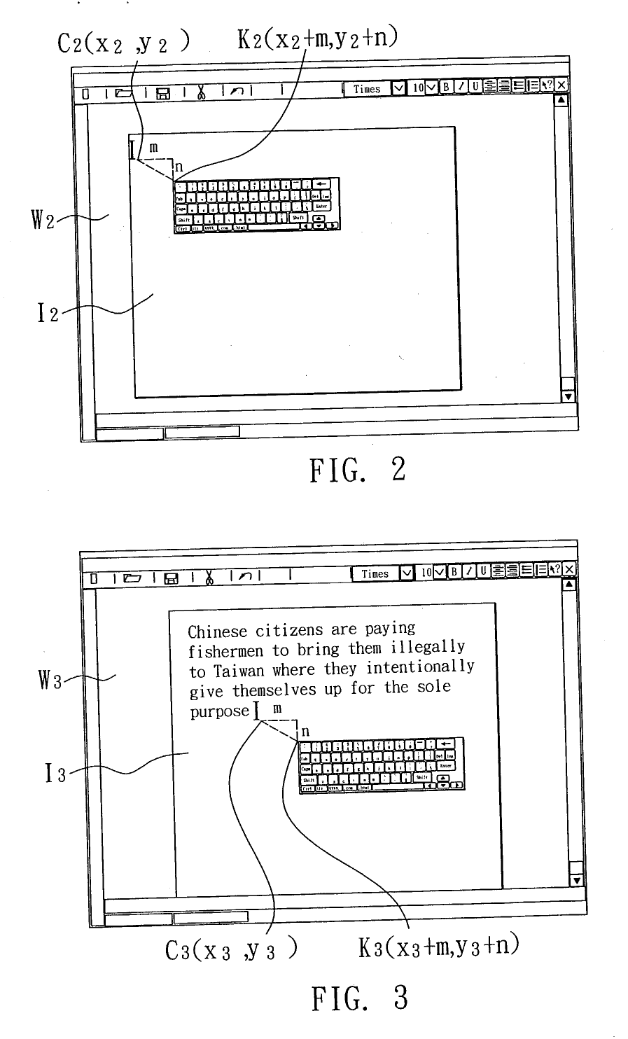

In the present invention, a software keyboard will automatically appear on the display of the information apparatus. Please refer to FIG. 1. FIG. 1 is a flowchart of a first embodiment according to the present invention. When the user executes an application to open a window W₂, as shown in FIG. 2 (step S101), the information apparatus detects a caret symbol C₂ generated in an input area (step S102) and calculates a coordinate value (x₂,y₂) for the caret symbol C₂ (step S103). Then, the information apparatus displays a software keyboard K₂ at a position with a coordinate value (x₂+m,y₂+n) (step S104). The m value is a predetermined horizontal distance, and the n value is a predetermined vertical distance. As shown in FIG. 2, the software keyboard K₂ appears near lower right region of the caret symbol C₂ (depending on the values of m and n, the software keyboard may also appear in the upper left region of the caret symbol C₂), and so the software keyboard K₂ does not cover the input area being used by the user.

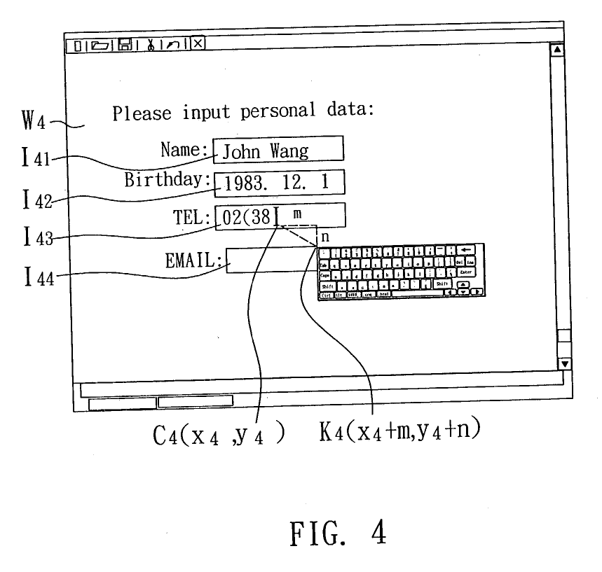

After the user inputs a string in the input area I₂, since the caret symbol C₂ moves with new input character, the software keyboard K₂ will move according to the movement of the caret symbol C₂. Please refer to FIG. 3. After the user inputs the text, “Chinese citizens are paying fishermen to bring them illegally to Taiwan where they intentionally give themselves up for the sole purpose”, the caret symbol C₂ originally having the coordinate value (x₂,y₂) as shown in FIG. 2 has now moved to the another position with a coordinate value of (x₃,y₃), and so the software keyboard K₂ with the coordinate value (x₂+m,y₂+n) has moved to a position with a coordinate value of (x₃+m,y₃+n). When the user switches the window W₂ to another window W₄ as shown in FIG. 4 (step S105), the information apparatus will remove the setting for the software keyboard K₂ in the window W₂ and re-detect a caret symbol C₄ and its corresponding coordinate (x₄,y₄) in the window W₄, thus displaying a software keyboard K₄ with a coordinate value given by (x₄+m,y₄+n). Furthermore, if the user moves the caret symbol C₄ from an input area 143 to another input area 144, the keyboard K₄ will move accordingly.

Additionally, in step S102, if there is no caret symbol generated in the input area of the active window, or there is no input area in the window, the software keyboard is hidden (step S106). Moreover, when the software keyboard moves near the edge of the display and so is unable to move further down or to the right, the software keyboard instead moves in an opposite direction (i.e. further up or further to the left).

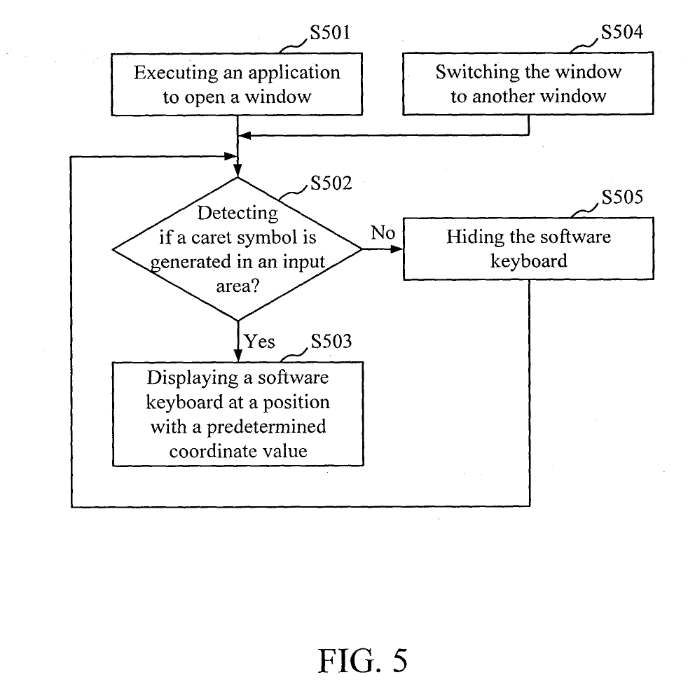

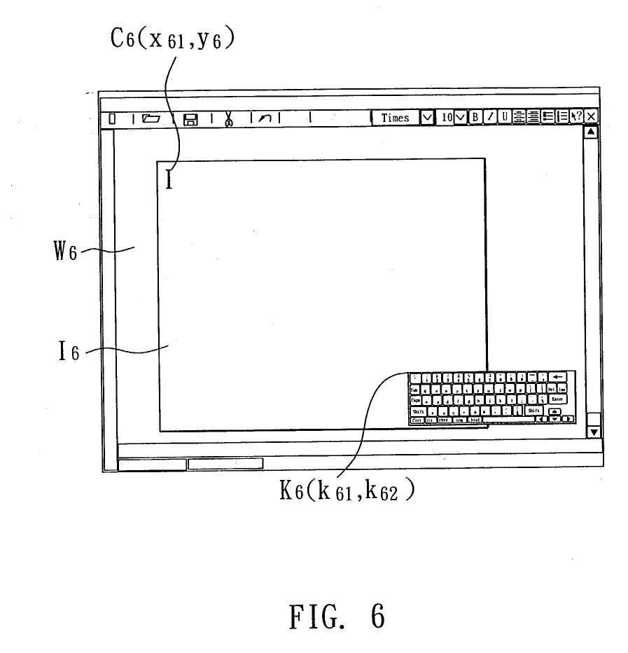

Please refer to FIG. 5 and FIG. 6. FIG. 5 is a flowchart of a second embodiment according to the present invention. FIG. 6 is a schematic drawing of the software keyboard of the second embodiment according to the present invention. The second embodiment is similar to the first embodiment, but whereas in the first embodiment the software keyboard moves according with the position of the caret symbol, in the second embodiment when the information apparatus detects a caret symbol C₆ generated in an input area I₆ on the window W₆ (step S502), the software keyboard K₆ appears at a position with a predetermined coordinate value (k₆₁,k₆₂) (step S503). Hence, regardless of where the caret symbol is, the software keyboard will always appear at the same predetermined position. But the user still can drag and drop the software keyboard to any other position on the display.

According to the above-mentioned description, the method of the present invention automatically displays/hides the software keyboard by detecting if the caret symbol is generated in input area of the active window, and so the user does not need to manually start the software keyboard. Furthermore, in the present invention the software keyboard appears at an appropriate position that does not cover the input area. Finally, the software keyboard provided by the present invention can support the inputting of multiple languages.

The invention has been described using exemplary preferred embodiments. However, for those skilled in this field the preferred embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

Although the present invention has been explained in relation to its preferred embodiment, it is to be understood that many other possible modifications and variations can be made without departing from the spirit and scope of the invention as hereinafter claimed.

What is claimed is:

1. A method of displaying a software keyboard in an information device, the information device being used to execute at least one application program and having a display for displaying the software keyboard and a corresponding widow opened after one application program is executed, wherein the window has at least one input area and one non-input area, and when a caret symbol appears in the input area, an input process can be performed after the caret symbol, the method comprising:
(A) detecting if one input area on the active window has a caret symbol, and if so proceeding to the next step; and
(B) displaying the software keyboard on the display.

2. The method as claimed in claim 1, wherein the software keyboard is displayed at a position corresponding to a predetermined coordinate value.

3. The method as claimed in claim 1, wherein step (B) further comprises:
(B1) calculating a coordinate value of the caret symbol in the window; and
(B2) displaying the software keyboard near the position of the caret symbol according to the coordinate value of the caret symbol.

4. The method as claimed in claim 3, wherein the software keyboard is capable of moving according to a movement of the caret symbol.

5. The method as claimed in claim 3, wherein the coordinate value of the caret symbol is (x, y), and the software keyboard is displayed at the position with coordinate value (x+m, y+n), m being a predetermined horizontal distance, and n being a predetermined vertical distance.

6. The method as claimed in claim 1, wherein in step (A), if the input area on the active window has no caret symbol, the software keyboard is hidden.

7. The method as claimed in claim 1, wherein when the active window switches to another window, step (A) is repeated.

8. The method as claimed in claim 1, wherein the display of the information device is a touch screen, and the input process is performed by touching keys of the software keyboard.

9. A computer readable memory media storing a software program and applied to an information device, the information device being used to execute at least one application program and having a display for displaying a software keyboard and a corresponding widow opened after one application program is executed, wherein the window has at least one input area and one non-input area, and when a caret symbol appears in the input area, an input process can be performed after the caret symbol, the soft ware program comprising:
a first program code, for detecting if one input area on the active window has a caret symbol; and
a second program code for displaying the software keyboard on the display in response to a detection performed in the first program code.

10. The readable memory media as claimed in claim 9, wherein the software keyboard is displayed at a position corresponding to a predetermined coordinate value.

11. The readable memory media as claimed in claim 9, wherein the second program code further comprises:
a 2A program code for calculating a coordinate value of the caret symbol in the window; and
a 2B program code for displaying the software keyboard near the position of the caret symbol according to the coordinate value of the caret symbol.

12. The readable memory media as claimed in claim 11, wherein the software keyboard movies capable of moving according to a movement of the caret symbol.

13. The readable memory media as claimed in claim 11, wherein the coordinate value of the caret symbol is (x, y), and the software keyboard is displayed at the position with coordinate value (x+m, y+n), m being a predetermined horizontal distance, and n being a predetermined vertical distance.

14. The readable memory media as claimed in claim 9, wherein in the first program code, if the input area on the active window has no caret symbol, the software keyboard is hidden.

15. The readable memory media as claimed in claim 9, wherein when the active window is switched to another window, the first program code is repeated.
